(19) United States
(12) Patent Application Publication
(10) Pub. No.: US 2006/0263486 A1
(43) Pub. Date: Nov. 23, 2006

(54) Filler material for a beverage container

(76) Inventors: Ralf Jager, Freising (DE); Martin Purpura, Bonn (DE); Reinhard Kroner, Freilassing (DE)

Correspondence Address: FULBRIGHT & JAWORSKI, LLP, 666 FIFTH AVE, NEW YORK, NY, 10103-3198, US

(21) Appl. No.: 11/131,921

(22) Filed: May 18, 2005

(51) Int. Cl. A23L 1/30

(52) U.S. Cl. 426/72

(57) ABSTRACT

The subject of the present invention relates to a filler material for a container having at least one chamber which is situated in a beverage container under pressure and immediately after the opening of the beverage container is suitable for the admixture of the filler material into the beverage liquid surrounding it. The filler material itself is in granule form and is composed of the chief component a) in the form of a nutritional supplement and an effervescent component b). The component a), which should be present in the filler material in percentages between 35 and 98 wt.-%, can be non-prescription agents, vitamins, creatine derivatives, phospholipids, probiotics, minerals, unsaturated fatty acids and any mixtures thereof. The fillers can be put into beverage liquids with varying pH, since due to their dissolving ability and due to the targeted selection of appropriate effervescence and bursting components can be dissolved quickly and completely in the beverage liquid.

The subject of the present invention is a filler material for a beverage container. The filler material itself is situated in a container having at least one chamber and that is situated in a beverage container that is under excess pressure, the container being able to mix the filler material into the beverage liquid surrounding it, immediately after the beverage container is opened.

Such combinations, consisting of a chamber container and a beverage container surrounding it, have long been known in the state of the art. The chamber containers are usually called “twin compartment widged” or multi-chamber containers and serve for putting special additives into usually carbonated beverages.

European Patent EP 1 073 593 discloses a typical two-chamber container which serves for putting additives into beverages. These additives are more precisely called aromas, the flavoring of beer being given as their principal use.

US published Patent 2002/0155199 describes a typical two-chambered container which is able to float free in the beverage surrounding it, and it is appropriate especially for containing liquids, material in paste form, powders and solids. These filler materials are aromas, dyes and other agents, such as sugar and milk, which in this case are to be put into beverages containing coffee.

Also, European patent application EP-A 0 747 298 claims a capsule container for beverage cans, the capsule container described therein being, however, considered only for putting so-called “gas-jetting” capsules into beers.

The two-component container disclosed in the international application WO 96/24542 serves for putting hydrolysis-sensitive medicaments into liquids.

Two-chamber containers and the materials that fill them are thus very well known in the state of the art, although the filler materials in most cases do not have any physiological activity, but are intended only to serve for providing beverages with certain color or taste properties. Only in exceptional cases do two-component containers contain hydrolysis-sensitive substance, which involve exclusively medicaments.

It was therefore the problem for the present invention to produce filler materials for two- or more-compartment containers, which after their release from the chamber containing them into the beverage surrounding them provide the beverage with an additional nutrient physiological or health use, without the involvement of medicaments or other prescription materials. The filler material should be appropriate for a container having at least one chamber, which is in a beverage container under pressure, and is able immediately after the beverage container is opened to mix the filler material into the beverage surrounding it.

This problem is solved by a corresponding filler material which is in granule form and consists of the main component a) in the form of a nutritional supplement as well as an additional component b) in the form of an adjuvant for dissolving component a) in the beverage.

It has surprisingly been found that the chosen and actually well known granulate form provides the claimed filler material with properties which facilitate putting the active substances into the beverage, have a positive influence on the dissolving of the filler material components and furthermore assure the complete dissolution of the components of the filler material in the particular beverage within a short time. Moreover, the specific filler material according to the invention permits the input of nutritional supplements which, when in powder form find only poor acceptance by consumers because either they cause an unpleasant swallowing sensation, have a poor taste or leave an unpleasant aftertaste, or else have poor solubility. The stated advantages were not to be expected in the form described.

A legally binding definition of the term, “nutritional supplements” does not yet exist. However, recognized proposals exist for the definition of the term, which clearly distinguish nutritional supplements as such: In 1998, the Bundesinstitut für gesundheitlichen Verbraucherschutz und Veterinärmedizin (BgVV) [Federal Institute For Consumer Health Protection and Veterinary Medicine] established nutritional supplements as foods which contain one or more nutrients in concentrated form and are in a form not typical of foods (tablets, capsules etc.).

In Germany the “Expert Committee of Foodstuff Chemists of the Federal States” in the years 1998 and 1999, defined nutritional supplements (unless they serve dietetic purposes) as foods of general consumption. They are usually offered for sale in a form not typical of foods, e.g., as capsules, granules, powders, ampoules and drops. Moreover, nutritional supplements serve to supplement common nutrition with known nutrients, but not to supply energy. They are furthermore to serve to assure the supply of substances necessary for physiologically necessary nutrition when the latter cannot be supplied in sufficient amount by unilateral nutrition. The kind and amount of these foods must be unobjectionable in the amount recommended for consumption.

Nutritional supplements are generally offered in forms which contain physiologically important substances, such as vitamins, minerals, amino acids, fatty acids and other substances which unlike medicines do not require approval of the “German Federal Bureau for Drugs and Medical Products”, and otherwise are to be classed with foods.

The present invention thus defines the term “nutritional supplements” as foods which contain a nutritionally important food in a concentrated amount, are in a form not typical of a food, generally serve to supplement common nutrition and assure the supply of nutritionally necessary substances and are unobjectionable as regards health in the administered manner and amount. Also, these nutritional supplements are not subject to approval, i.e., they are not subject to the approval of the “German Federal Bureau for Drugs and Medical Products”. In certain cases they can serve a dietetic purpose if the above-mentioned conditions are observed.

It has proven especially advantageous if the claimed filler material contains the component a) in percentages of 35 to 98 wt.-% and component b) in amounts of 2 to 65 wt.-%. Regarding component a), contents of 45 to 80 wt.-% apply, and those between 55 and 70 wt.-% are especially preferred. Component b) should be contained in the filler material in amounts between 7 and 55 wt.-%, preferably between 15 and 40 wt.-% and with special preference between 20 and 30 wt.-%.

As already indicated, the actual physiological active component of the claimed filler material, namely the nutritional supplement, can be selected from a relatively broad range, since the only conditions it must satisfy are those on which a typical nutrient supplement is based. Preferably the filler material is selected from the series of the non-prescription pharmaceutical agents, the vitamins, the phospholipids, probiotics, minerals and unsaturated fatty acids, but even creatine is naturally suitable. Also possible, of course, is the use of any suitable salts and derivatives of the named agents, and any mixtures.

Acetylsalicylic acid and its derivatives can be mentioned as especially suitable component a). But also representatives of the vitamins A, C and E, riboflavin and folic acid represent typical and very suitable representatives of the claimed filler materials. Furthermore, creatine monohydrate, creatine pyruvate and all possible creatine/citric acid compounds, especially creatine citrate can be involved. Of the phospholipid series, phosphatidyl serine, phosphatidyl choline, phosphatidyl ethanolamine and phosphatidyl inositol have proven to be especially suitable. In the scope of the present invention, especially preferred unsaturated fatty acids are docosahexaenoic acid (DHA), eicosapentaenoic acid (CPA), conjugated linolic acid (CLA) and arachidonic acid (ARA).

Regarding the second component of the claimed filler material important to the invention, namely component b), the present invention provides especially effervescent components, all carbon dioxide-releasing compounds being basically appropriate, and especially carbonate and hydrogen carbonate salts being involved. Depending on the particular pH range of the beverage, however, organic acids are suitable, and especially citric acid, phosphoric acid, malic acid and tartaric acid, which either alone or in combination with carbonate salts provide for the effervescent effect supporting the dissolving of the active component in the beverage.

In the case of component b), however, a bursting agent can also be involved according to the invention. In this connection, the present invention recommends substances which swell rapidly in solution and especially in aqueous solution. But also appropriate are compounds known as crosslinking agents, and above all mixtures thereof, sodium carboxymethyl cellulose being known as a typical crosslinker, which is also known as croscarmellulose sodium, alginic acid, low-substituted hydroxypropyl cellulose and starch glycolates, as well as crosslinked N-vinyl-2-pyrrolidones (so-called crospovidones).

An especially advantageous filler material is obtained according to the invention when it contains component b) as a bursting agent in amounts equal to or less than 10 wt.-%.

The novel feature of the filler material of the invention is its granular form. Surprisingly, the granules suitable as filler material are not limited to a narrow range of grain sizes, but the individual grains can have a relatively large diameter without thereby exhibiting a poor or slow dissolution in the beverage. The present invention therefore also considers preferred granules with an average grain diameter of 1.0 to 7.0 mm, grain diameters between 2.5 and 6.0 mm being preferred and diameters between 3.0 and 5.0 mm are to be considered especially preferred.

Also, the composition of the granules can be freely chosen within the limits set by the invention. Thus, the claimed filler material can consist of granules which are composed homogeneously or heterogeneously as regards ingredients. This signifies that the individual grains contain either one of the components according to the invention, or both of them. But also mixtures of these variants are possible. Thus, granules can be involved which contain only the nutritional supplement component, and in addition granules which have the effervescent component and/or the bursting agent.

Also, no limiting effect is to be attributed to the grain size distribution within the filler material. Depending on the beverage and the requirements made in connection therewith for the dissolving behavior of the filler material, the granules either in plurality may show a grain size up to 3.0 mm or in plurality have a single grain size of at least 2.5 mm. Additionally, the amount of granules in the filler material may be freely chosen, depending from the volume, the size and/or the design of the container.

In particular, the present invention provides that filler materials are suitable for addition to beverages if they have a pH less than 7.0 and especially between 2.0 and 5.0, while a pH ranging between 2.5 and 4.5 is to be considered as especially preferred in this connection.

Alternatively, however, filler materials may also be suitable for addition to beverages, which have a pH≧7.0. Here a pH that is between 8.0 and 11.0 is especially preferred.

As regards the beverages surrounding the chamber container, refreshing beverages are considered by the present invention to be especially preferred, variants being of special interest which are carbonated and principally alcoholic. Refreshing beverages in the scope of the present invention are soft drinks, fruit juice drinks, milk-based beverages which may also be fermented, beers (full beers, and reduced-alcoholic and non-alcoholic beers), alcoholic mixed drinks, i.e., so-called “Alkopops,” and especially those of the spritzer type.

Since the release of the filler material from the chamber container into the beverage surrounding it is usually possible, for technical reasons, when the beverage container itself is under pressure, the present invention takes into account a variant in which the filler material is appropriate for use in beverage cans in which the beverage is under an excess pressure in relation to the chamber container. This excess pressure is not subject to any minimum limit, but needs only to suffice to release the filler material, in the instance of the opening of the beverage container (thus, as a rule the beverage can), entirely into the beverage. Usually, an excess pressure of more or equal to 0.3 bar is sufficient. Beverage containers may be in the form of typical containers made from metal or plastic, that are used by pressing or pulling the opening strip. Also suitable are container variants, such as plastic/cardboard composites, with the provision that they can withstand the pressure conditions.

With the filler material according to the invention in granular form it is possible to store nutritional supplements that are liable to hydrolysis, or other compound-relevant compliance properties, separately from beverage mixtures for a long time, and then mix them quickly and completely into the beverage liquid. In this manner, nutritional supplements are made accessible in a new form for dispensation in broader fields of application.

A requirement for the achievement of the advantages described is, of course, the complete dissolution of the nutritional supplement component a). Here component b) plays an important part in the dissolving of the physiological agents, on account of its ability to evolve volumes of gas or to act as a bursting agent. In that case component b) does not act as a solubilizer, i.e., not as a typical emulsifier or as a dispersant, but acts on component a) and its dissolving action rather mechanically or chemically, for example by a change of its pH.

Of course, the claimed filler material can contain, in addition to the two components a) and b), common additives and formulation adjuvants, such as flavoring, colors, sugar, separators, acidifiers, sweeteners and others, which do not fall under the definition given as nutritional supplements, and also have no important influence on the dissolving of component a) in the beverage.

The following examples name typical filler materials according to the present invention.

### EXAMPLES

### Example 1

A mixture consisting of 75 wt.-% creatine citrate and 25 wt.-% sodium hydrogen carbonate was granulated with a Bepax CS 25 compactor, a breaker and a sieving machine such that the granules had a grain size distribution of 98%>2.5 mm and 99%>5 mm. The press pressure, the cylinder speed and the screw speed were adjusted such that the granules completely dissolved or dispersed in water at pH=3 under the action of citric acid as effervescent component within one minute at 20° C. water temperature.

### Example 2

A mixture of 20 wt.-% potassium hydrogen carbonate (effervescent component) and a nutritional supplement component consisting of 40% calcium lactate gluconate, 20 wt.-% ascorbic acid, 1 wt.-% zinc sulfate, 14 wt.-% magnesium citrate, 0.5 wt.-% manganese aspartate, 0.5 wt.-% vitamin A palmitate, 0.5 wt.-% vitamin E acetate, 0.5 wt.-% riboflavin and 3 wt.-% sodium carboxymethyl cellulose as bursting agent, was granulated with a Bepex CS 25 compactor, breaker and a sieving machine such that the granules formed have grain size distribution of 97%>2 mm and 98%<5 mm. (The weights relate only to the total weight of the filler material). The press pressure, the cylinder speed and the screw speed were adjusted such that the granules dissolved or dispersed in water at pH=3 and in the presence of citric acid within one minute at 20° C.

### Example 3

A mixture of 35 wt.-% acetylsalicylic acid, 55 wt.-% citric acid (effervescent component) and 10 wt.-% of sodium carboxymethylcellulose (bursting agent) was granulated with a Bepex CS 25 compactor, a breaker and a sieving machine such that the resulting granules had a grain size distribution of 97%>1 mm and 98 wt.-%<3 mm. (The weights relate to the total weight of the filler material). In this case the press pressure, roller speed and screw speed were so adjusted that the granules dissolved or dispersed completely in water at pH=11 (by means of sodium carbonate and sodium hydrogen carbonate) within one minute at 20° C. water temperature.

1-14. (canceled)

15. A filler material in granular form and comprise component a) a nutritional supplement and component b) an adjuvant for dissolving said component a) in the beverage liquid.

16. A filler material according to claim 15, comprising 35 to 98 wt.-% component a) and 2 to 65 wt.-% component b).

17. A filler material according to claim 15, wherein component a) is selected from the group consisting of a non-prescription pharmaceutical agent, a vitamin, creatine, a phospholipid, a probiotic, a mineral, an unsaturated fatty acid, derivatives thereof and mixtures thereof.

18. A filler material according to claim 16, wherein component a) is selected from the group consisting of a non-prescription pharmaceutical agent, a vitamin, creatine, a phospholipid, a probiotic, a mineral, an unsaturated fatty acid, derivatives thereof and a mixture thereof.

19. A filler material according to claim 15, wherein component a) is acetylsalicylic acid, representatives of vitamin A, C or E, riboflavin, folic acid, creatine monohydrate, creatine pyruvate, a creatine/citric acid compound, creatine citrate, phosphatidyl serine, phosphatidyl choline, phosphatidyl ethanolamine, phosphatidyl inositol, docosahexaeneoic acid (DHA), eicosapentaenoic acid (EPA), conjugated linolic acid (CLA), or arachidonic acid (ARA).

20. A filler material according to claim 16, wherein component a) is acetylsalicylic acid, representatives of vitamin A, C or E, riboflavin, folic acid, creatine monohydrate, creatine pyruvate, a creatine/citric acid compound, creatine citrate, phosphatidyl serine, phosphatidyl choline, phosphatidyl ethanolamine, phosphatidyl inositol, docosahexaeneoic acid (DHA), eicosapentaenoic acid (EPA), conjugated linolic acid (CLA), or arachidonic acid (ARA).

21. A filler material according to claim 15, wherein component b) is an effervescent component.

22. A filler material according to claim 15, wherein the component b) is a carbon dioxide-releasing compound.

23. The filler material according to claim 15, wherein component b) is a carbonate salt a hydrogen carbonate salt, or an organic acid.

24. The filler material according to claim 15, wherein component b) is citric acid, phosphoric acid, malic acid or tartaric acid.

25. The filler material according to claim 15, wherein component b) is a bursting agent.

26. The filler material according to claim 15, wherein component b) is a substance that swells rapidly in solution or is a mixture of crosslinking agents.

27. The filler material according to claim 15, wherein component b) is sodium carboxymethylcellulose (croscarmellulose sodium), alginic acid, low-substituted hydroxypropyl cellulose, a starch glycolate or crosslinked N-vinyl-2-pyrrolidone (crospovidone).

28. The filler material according to claim 25, wherein the bursting agent is present in an amount of ≦10 wt.-%.

29. The filler material according to claim 15, wherein the granules have an average grain diameter of 1.0 to 7.0 mm.

30. The filler material according to claim 29, wherein the average grain diameter is 2.5 to 6.0 mm.

31. The filler material according to claim 30, wherein the average grain diameter is from 3.0 to 5.0 mm.

32. The filler material according to claim 15, wherein the granules comprise components a) and/or b) and/or, in some cases, c).

33. The filler material according to claim 15, wherein the filler material is suitable for putting into beverage liquids which have a pH<7.0.

34. The filler material according to claim 33, wherein said pH is from 2.0 to 5.0.

35. The filler material according to claim 33, wherein said pH is from 2.5 to 4.5.

36. The filler material according to claim 15, wherein the filler material is suitable for addition to beverages which have a pH≧7.0.

37. The filler material according to claim 36, wherein said pH is 8.0 to 11.0.

38. The filler material according to claim 15, wherein the filler material is suitable for addition to beverages which have a pH greater than or equal to 7.0.

39. The filler material according to claim 38, wherein the pH is 7.0.

40. The filler material according to claim 38, wherein the pH is 8.0.

41. A filler material according to claim 15, wherein the filler material is suitable for a refreshing beverage of the group selected from soft drinks, a fruit-juice beverage, a milk-based beverage which is optionally fermented, a beer and an alcoholic mixed drink.

42. The filler material according to claim 41, wherein the beverage is a spritzer.

43. The filler material according to claim 15, wherein the filler material is suitable for beverage cans whose beverage has an excess pressure of ≧0.3 bar in relation to the chamber container.

44. A container comprising at least one chamber, and being situated in a beverage container with a beverage under pressure, and showing an opening area, and containing a filler material according to claim 15.

45. The container of claim 44, wherein the filler material is suitable for beverage cans whose beverage has an excess pressure of ≧0.3 bar in relation to the chamber container.

46. The container of claim 44, wherein the filler material, immediately after opening the beverage container, is able to mix with the beverage liquid.

47. The container of claim 44, wherein the beverage is a refreshing drink.

48. The container of claim 44, wherein the beverage is carbonated.

49. The container of claim 44, wherein the beverage is alcoholic.
